(19) United States
(12) Patent Application Publication
(10) Pub. No.: US 2013/0149008 A1
(43) Pub. Date: Jun. 13, 2013

(54) IMAGE FORMING APPARATUS

(71) Applicants: Noboru OOMOTO, Toyokawa-shi (JP); Shoichi Yoshikawa, Okazaki-shi (JP); Tadayasu Sekioka, Toyohashi-shi (JP); Yoshiyuki Toso, Toyokawa-shi (JP); Takashi Fujiwara, Hachioji-shi (JP); Naoki Miyagawa, Toyokawa-shi (JP)

(72) Inventors: Noboru OOMOTO, Toyokawa-shi (JP); Shoichi Yoshikawa, Okazaki-shi (JP); Tadayasu Sekioka, Toyohashi-shi (JP); Yoshiyuki Toso, Toyokawa-shi (JP); Takashi Fujiwara, Hachioji-shi (JP); Naoki Miyagawa, Toyokawa-shi (JP)

(73) Assignee: KONICA MINOLTA BUSINESS TECHNOLOGIES, INC., Tokyo (JP)

(21) Appl. No.: 13/693,543

(22) Filed: Dec. 4, 2012

(30) Foreign Application Priority Data
Dec. 9, 2011 (JP) 2011-269787

(51) Int. Cl. G03G 15/00

(52) U.S. Cl. CPC G03G 15/00
USPC 399/167

(57) ABSTRACT

An image forming apparatus includes: a driving source configured to generate power; a first rotator configured to be drivingly rotated by the power generated by the driving source; a first power transmission system configured to transmit the power from the driving source to the first rotator; a second rotator configured to be drivingly rotated by the power generated by the driving source; and a second power transmission system configured to transmit the power to the second rotator from the first power transmission system. A damper having a torsion spring constant and a torsion viscous damping constant making a maximum positional change value of the first rotator equal to or smaller than a predetermined positional change value is disposed between the first power transmission system and the second power transmission system.

### CROSS-REFERENCE TO RELATED APPLICATIONS

The present application claims priority under 35 U.S.C. §119 to Japanese Patent Application No. 2011-269787, filed Dec. 9, 2011. The contents of this application are incorporated herein by reference in their entirety.

### BACKGROUND OF THE INVENTION

1. Field of the Invention

The present invention relates to an image forming apparatus including copiers, printers, fax machines, and multi-function machines integrally incorporating copy, printing and fax capabilities.

2. Discussion of the Background

Electrographic image forming apparatuses obtain images by forming an electrostatic latent image on the surface of a rotating photoreceptor, visualizing the electrostatic latent image into a toner image on a developer, and electrostatically transferring the toner image onto a recording medium. Japanese Unexamined Patent Application Publication No. H7-140744 discloses an electrographic image forming apparatus of this kind. In the electrographic image forming apparatus, a plurality of consumables such as a photoreceptor, a charger, a developer, and a cleaner subject to wear through repeated image forming operations are integrated into what is called a process cartridge, which is removable and exchangeable.

Preferably, the process cartridge, which is a consumable, is provided at a reasonable price for a user and has a small size and a light weight so that a large storage space is not required. In view of this, the process cartridge in Japanese Unexamined Patent Application Publication No. 1995-140744 employs a configuration where a drum gear secured to a photoreceptor meshes with a roller gear secured to a developer (developing roller) so that the photoreceptor and the developer are power transmittably coupled to each other to simplify the power transmission system and reduce size and weight of the power transmission system.

However, according to the configuration employed for the process cartridge of Japanese Unexamined Patent Application Publication No. 1995-140744, the drum gear secured to the photoreceptor meshes with the roller gear secured to the developer (developing roller), and thus the photoreceptor is likely to be affected by varying loads on the developer during the visualization. Here, the rotation rate of the photoreceptor varies by the influence of the varying loads on the developer. As a result, a band shaped image blurring (banding) is produced on the image, and thus the image quality is degraded. The variations in rotation rate (varying rotation rates) of the photoreceptor might be caused by various causes other than the varying loads on the developer, for example variations in rotation rate of a driving source provided on a side of a main body and a transmission error produced by meshing between gears. Accordingly, the problem described above does not typically appear in the image forming apparatus in which the exchangeable process cartridge can be used, but commonly appears in image forming apparatuses in general.

### SUMMARY OF THE INVENTION

An image forming apparatus according to a first aspect of the present invention includes: a driving source configured to generate power; a first rotator configured to be drivingly rotated by the power generated by the driving source; a first power transmission system configured to transmit the power from the driving source to the first rotator; a second rotator configured to be drivingly rotated by the power generated by the driving source; and a second power transmission system configured to transmit the power to the second rotator from the first power transmission system or from the first rotator. A damper to damp oscillation is disposed between the first power transmission system and the second power transmission system or between the first rotator and the second power transmission system. The damper has a torsion spring constant and a torsion viscous damping constant making a maximum positional change value of the first rotator equal to or smaller than a predetermined positional change value.

A second aspect of the present invention is that, in the image forming apparatus according to the first aspect, the torsion spring constant of the damper may be equal to or smaller than 45 Nmm/rad, and the torsion viscous damping constant of the damper may be equal to or larger than 90 Nmms/rad.

A third aspect of the present invention is that, in the image forming apparatus according to the first aspect or the second aspect, the damper may include a viscoelastic body configured to couple the second power transmission system to the first power transmission system or the first rotator so as to rotate the second power transmission system in conjunction with the first power transmission system or the first rotator.

A fourth aspect of the present invention is that, in the image forming apparatus according to the third aspect, the second power transmission system and the first power transmission system or the first rotator may be coaxially disposed, and the damper may be disposed in an annular form between the second power transmission system and the first power transmission system or the first rotator.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic explanatory view of a printer;

FIG. 2 is a schematic explanatory view of a power transmission system of an image forming unit according to a first embodiment;

FIG. 3 is a perspective view of the power transmission system of the image forming unit;

FIG. 4 is a graph showing a comparison in a rotational oscillation response function among cases where a torsion spring constant of a viscoelastic body is small, medium, and large;

FIG. 5 is a graph showing a comparison in a rotational oscillation response function among cases where a torsion viscous damping constant of a viscoelastic body is small, medium, and large;

FIGS. 6A to FIG. 6D are graphs showing the effects of elasticity and viscosity of the viscoelastic body on varying rotation rates of a photoreceptor;

FIG. 7 is a graph showing relationships between the elasticity and the viscosity characteristics of the viscoelastic body and a zero peak value of the photoreceptor;

FIG. 8 is a perspective view of a power transmission system of an image forming unit according to a second embodiment;

FIG. 9 is a schematic explanatory view of the power transmission system of the image forming unit;

FIG. 10 is a schematic explanatory view of a power transmission system of an image forming unit according to a third embodiment; and

FIG. 11 is a schematic explanatory view of a power transmission system of an image forming unit according to a fourth embodiment.

### DESCRIPTION OF THE PREFERRED EMBODIMENTS

The embodiments will now be described with reference to the accompanying drawings, wherein like reference numerals designate corresponding or identical elements throughout the various drawings.

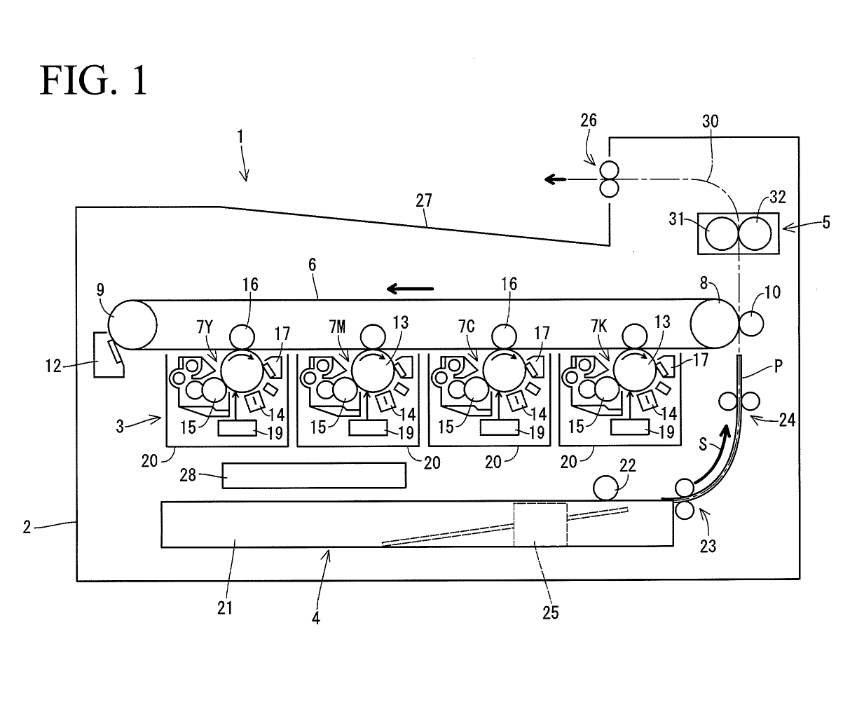

In the embodiments, a tandem color digital printer (hereinafter referred to as a printer) will be described as an example of the image forming apparatus. In the following description, terms (for example, “left and right” and “upper and lower”) indicating specific directions and positions are used where necessary. In this respect, the direction perpendicular to the paper plane of FIG. 1 is defined as front view. The terms are used for the sake of description and will not limit the technical scope of the present invention.

### (1) Overview of the Printer

First, an overview of a printer 1 will be described by referring to FIG. 1. As shown in FIG. 1, the printer 1 according to this embodiment includes, in a casing 2, an image processor 3, a sheet feeder 4, and a fixing device 5. The printer 1 is coupled to a network such as a LAN so that upon receipt of a print command from an external terminal (not shown), the printer 1 executes printing based on the command, which is not elaborated in the drawings.

The sheet feeder 4 is positioned at a lower portion of the casing 2 and includes a sheet feed cassette 21, a pickup roller 22, a pair of separation rollers 23, and a pair of timing rollers 24. The sheet feed cassette 21 accommodates recording media P. The pickup roller 22 picks up an uppermost part of the recording media P in the sheet feed cassette 21. The pair of separation rollers 23 separate the picked part of recording media P into individual sheets. The pair of timing rollers 24 transfer the individual sheets of recording medium P, one by one, to the image processor 3 at a predetermined timing. The recording media P in the sheet feed cassette 21 are sent to a conveyance path 30 one at a time from the top by the rotation of the pickup roller 22 and the separation rollers 23. The conveyance path 30 extends from the sheet feed cassette 21 of the sheet feeder 4 through a nip portion between the pair of timing rollers 24, a secondary transfer nip portion 11 of the image processor 3, and a fixing nip portion of the fixing device 5, to reach a pair of discharging rollers 26 at an upper portion of the casing 2.

In the sheet feed cassette 21, the recording media P are at a center reference on the sheet feed cassette 21 for conveyance toward the conveyance path 30 in the direction of arrow S. In this respect, the center of each recording medium P in its width direction (which is orthogonal to the transfer direction S) is used as a reference relative to the center reference. In this embodiment, the sheet feed cassette 21 includes a pair of side regulation plates 25 to hold unpicked recording media P across the width thereof so as to align the recording media P with the center reference. The pair of side regulation plates 25 simultaneously move close to or away from one another in the sheet width direction (which is orthogonal to the transfer direction S). In the sheet feed cassette 21, the pair of side regulation plates 25 hold both sides of the recording medium P in the sheet width direction. This ensures that recording media P of any standard are set at the center reference in the sheet feed cassette 21. Accordingly, the transfer process at the image processor 3 and the fixing process at the fixing device 5 are executed based on the center reference.

The image processor 3 is above the sheet feeder 4 and transfers toner images on photoreceptors 13, which are exemplary image carriers, to a recording medium P. The image processor 3 includes an intermediate transfer belt 6 and a total of four image forming units 7 respectively corresponding to colors of yellow (Y), magenta (M), cyan (C), and black (K). The intermediate transfer belt 6, which is another exemplary image carrier, is wound across a driving roller 8 and a driven roller 9 respectively disposed on right and left sides at a vertically central position of the casing 2. A secondary transfer roller 10 is disposed on the outer peripheral side of a portion of the intermediate transfer belt 6 wound around the driving roller 8. The intermediate transfer belt 6 and the secondary transfer roller 10 define, at the portion of their contact, a secondary transfer nip portion 11 as a secondary transfer region. A transfer belt cleaner 12 is disposed on the outer peripheral side of a portion of the intermediate transfer belt 6 wound around the driven roller 9. The transfer belt cleaner 12 removes un-transferred toner remaining on the intermediate transfer belt 6. The casing 2 includes a controller 28 in charge of overall control of the printer 1 between the image processor 3 and the sheet feeder 4. The controller 28 incorporates another controller (not shown) in charge of various arithmetic operations, storing, and control.

Below and along the intermediate transfer belt 6, the four image forming units 7 of yellow (Y), magenta (M), cyan (C), and black (K) are arranged in this order starting on the left side of FIG. 1. For the sake of description, in FIG. 1, the image forming units 7 are respectively labeled with symbols Y, M, C, and K in accordance with reproduced colors. Each image forming unit 7 includes a photoreceptor 13. Around the photoreceptor 13, a charger 14, an exposing unit 19, a developer 15, a primary transfer roller 16, and a photoreceptor cleaner 17 are arranged in this order in the clockwise rotational direction of FIG 1.

In each of the image forming units 7, the exposing unit 19 radiates a laser beam to the photoreceptor 13 charged by the charger 14, thus forming an electrostatic latent image. The electrostatic latent image is reverse-developed using toner supplied from the developer 15 into a toner image of a corresponding color. At primary transfer nip portions, the toner images of yellow, magenta, cyan, and black are primary transferred in this order on the outer circumferential surface of the intermediate transfer belt 6 from the photoreceptors 13, and superimposed one on top of each other. Un-transferred toner remaining on the photoreceptors 13 is scraped off the photoreceptors 13 by the respective photoreceptor cleaners 17. The superimposed toner images of the four colors are collectively secondary transferred on the recording medium P through the secondary transfer nip portion 11. Un-transferred toner remaining on the intermediate transfer belt 6 is scraped off the intermediate transfer belt 6 by the transfer belt cleaner 12.

The fixing device 5 is positioned above the secondary transfer roller 10 of the image processor 3, and includes a fixing roller 31 and a pressure roller 32. The fixing roller 31 incorporates a heat source such as a halogen heater. The pressure roller 32 is opposite the fixing roller 31. The fixing roller 31 and the pressure roller 32 define, at the portion of their contact, a fixing nip portion as a fixing region. The recording medium P past the secondary transfer nip portion 11 and loaded with an unfixed toner image is heated and pressed through the fixing nip portion between the fixing roller 31 and the pressure roller 32. Thus, the unfixed toner image is fixed on the recording medium P. Then, the recording medium P is discharged on a collection tray 27 by the rotation of the pair of discharging rollers 26.

For example, the developer 15 of each image forming unit 7, the intermediate transfer belt 6, and the transfer belt cleaner 12 are consumables subject to wear through repeated image forming operations. The consumables are exchangeably (removably) disposed in the casing 2. For example, each image forming unit 7 (the photoreceptor 13, the charger 14, the exposing unit 19, the developer 15, and the photoreceptor cleaner 17) is incorporated in a housing 20 in the form of a cartridge (integrated structure) and is exchangeably disposed in the casing 2 as what is called a process cartridge.

### (2) First Embodiment of Power Transmission Structure, Directed to Image Forming Unit

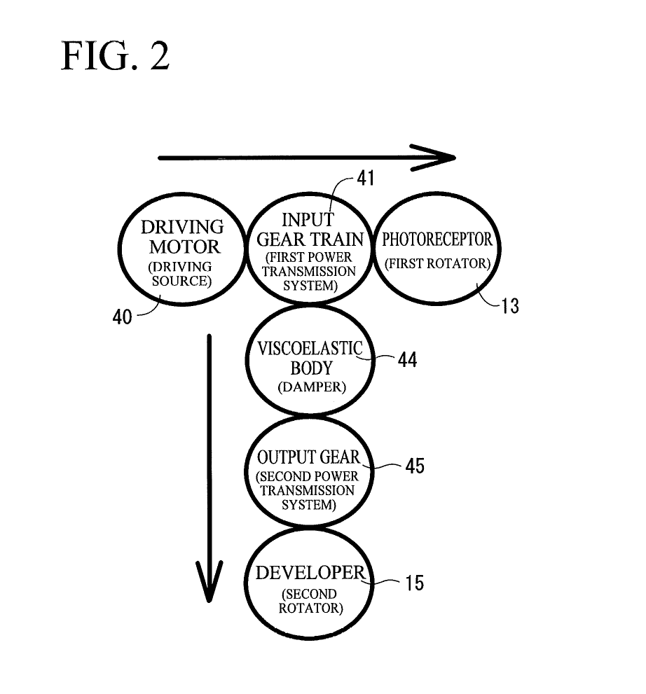

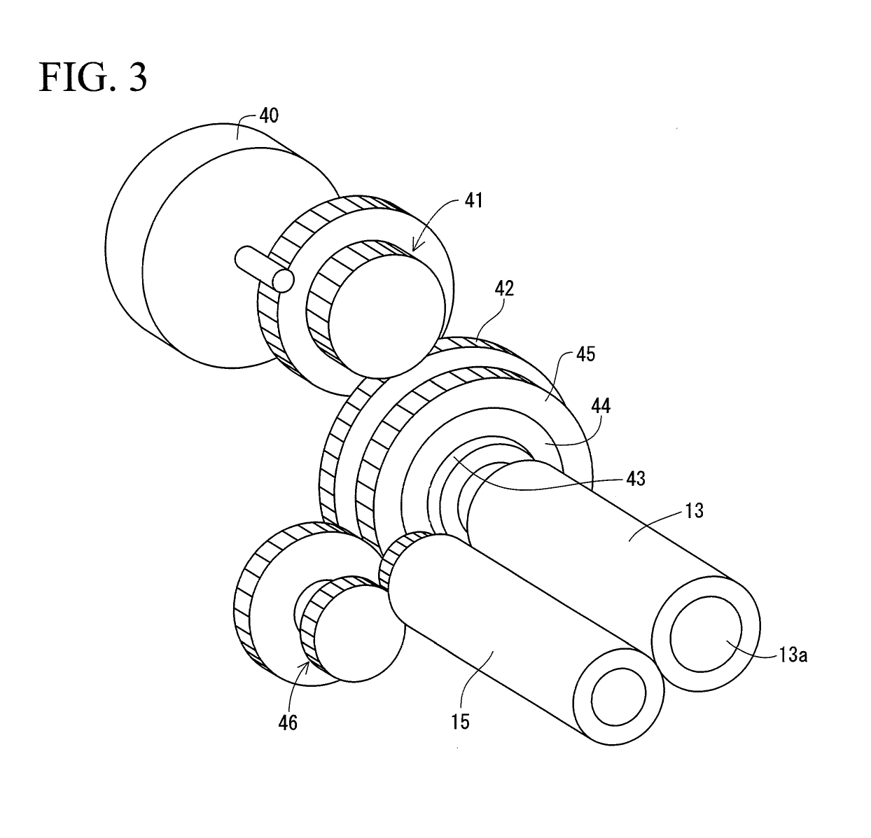

Referring to FIG. 2 and FIG. 3, a first embodiment of a power transmission structure directed to the image forming unit 7 will be described below. The printer 1 includes, on a side of the casing 2, a driving motor 40 serving as a driving source to generate power. In the first embodiment, the power generated by the driving motor 40 is branched into two directions, namely, to the photoreceptor 13 serving as a first rotator and to the developer 15 serving as a second rotator (see FIG. 2 and FIG. 3).

The power generated by the driving motor 40 is first transmitted to an input gear train 41 serving as a first power transmission system. The input gear train 41 meshes with a photoreceptor gear 42 coupled to a rotary shaft 13a of the photoreceptor 13, to transmit power to the photoreceptor gear 42. Thus, the photoreceptor 13 integrally rotates with the photoreceptor gear 42. An output branching gear 45 is a component of the second power transmission system and is unremovably secured to a boss section 43 of the photoreceptor gear 42, protruding on the side of the photoreceptor 13.

A viscoelastic body 44 serving as a damper to damp oscillations is disposed between the photoreceptor gear 42 and the output branching gear 45. The output branching gear 45 is power transmittably coupled to the developer 15 through an output gear train 46.

That is, part of the power generated by the driving motor 40 is transmitted to the photoreceptor 13 through the input gear train 41 and the photoreceptor gear 42. The rest of the power is transmitted to the output branching gear 45 from the photoreceptor gear 42 through the viscoelastic body 44, and then is further transmitted to the developer 15 through the output gear train 46. The viscoelastic body 44 may be anti-oscillation rubber such as flexibly and elastically deformable synthesized rubber. Examples include, but not limited to, chloroprene rubber, ethylene propylene rubber, silicone gel, oil impregnated cellular rubber, butyl rubber, and thermoplastic elastomer.

In this configuration, the power generated by the driving motor 40 is branched into two directions, namely, to the photoreceptor 13 and to the developer 15. In this respect, providing the viscoelastic body 44 between the photoreceptor gear 42 and the output branching gear 45 ensures that the viscoelastic body 44 damps oscillations resulting from, for example, varying rotation rates of the driving motor 40 and varying loads on the developer 15. This, as a result, significantly reduces varying rotation rates of the photoreceptor 13 and minimizes image blurring (banding), thereby improving image quality. It is particularly noted that the image forming unit 7 is exchangeably disposed in the casing 2 in the form of what is called a process cartridge, which additionally advantageously simplifies the power transmission system and reduces size and weight of the power transmission system.

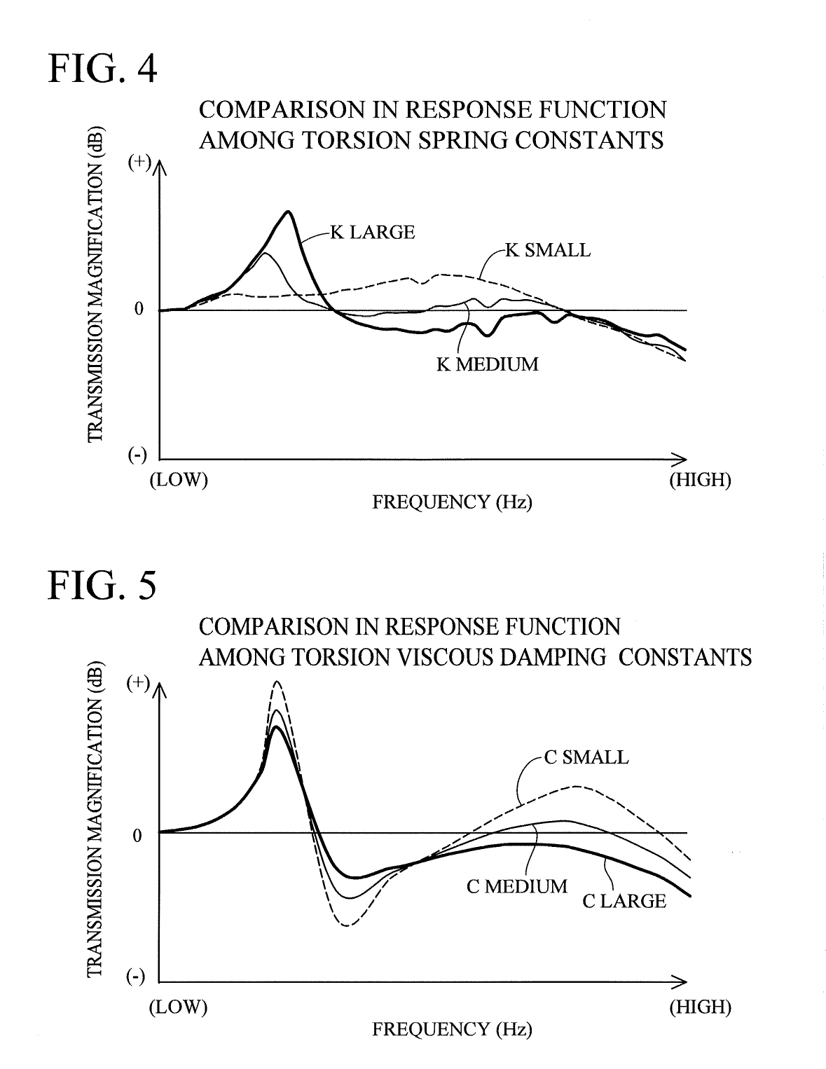

FIG. 4 shows a comparison in rotational oscillation response function among cases where a torsion spring constant K of the viscoelastic body 44 is large, medium, and small. FIG. 5 shows a comparison in rotational oscillation response function among cases where a torsion viscous damping constant C of the viscoelastic body 44 is large, medium, and small. Graphs of FIG. 4 and FIG. 5 show frequencies (Hz) on the horizontal axis and transmission magnifications (dB) on the vertical axis. The graphs of FIG. 4 and FIG. 5 are derived from a 2-degree-of-freedom vibration system model analysis, and the response functions thereof well match those actually measured. The input of the rotational oscillation is given by the driving motor 40, and the output of the rotational oscillation is detected by the photoreceptor 13.

As shown in the graphs of FIG. 4 and FIG. 5, the variations in the rotational oscillation response functions of the torsion spring constant K and the torsion viscous damping constant C are not simple as that in a single-degree-of-freedom vibration system model for example, and it is likely that a frequency leading to high transmission magnification and a frequency leading to low transmission magnification coexist. For example, the graph of FIG. 4 includes a low frequency range where a larger torsion spring constant K leads to a higher peak (larger transmission magnification), and a high frequency range where, conversely, a smaller torsion spring constant K leads to a higher peak. This means that, if the viscoelastic body 44 with high elasticity (large torsion spring constant K) is used as the damper, the rotational oscillation in the high frequency range is damped but the rotational oscillation in the low frequency range tends to increase, and if the viscoelastic body 44 with low elasticity (small torsion spring constant K) is used as the damper, the rotational oscillation in the low frequency range is damped but the rotational oscillation in the high frequency range tends to increase.

On the other hand, the graph of FIG. 5 includes low and high frequency ranges where a smaller torsion viscous damping constant C leads to a higher peak as well as a lower frequency side region where a smaller torsion viscous damping constant C leads to a lower peak (higher peak in the negative direction). Thus, the viscoelastic body 44 with high viscosity (large torsion viscous damping constant C) tends to damp the rotational oscillation over the entire frequency range.

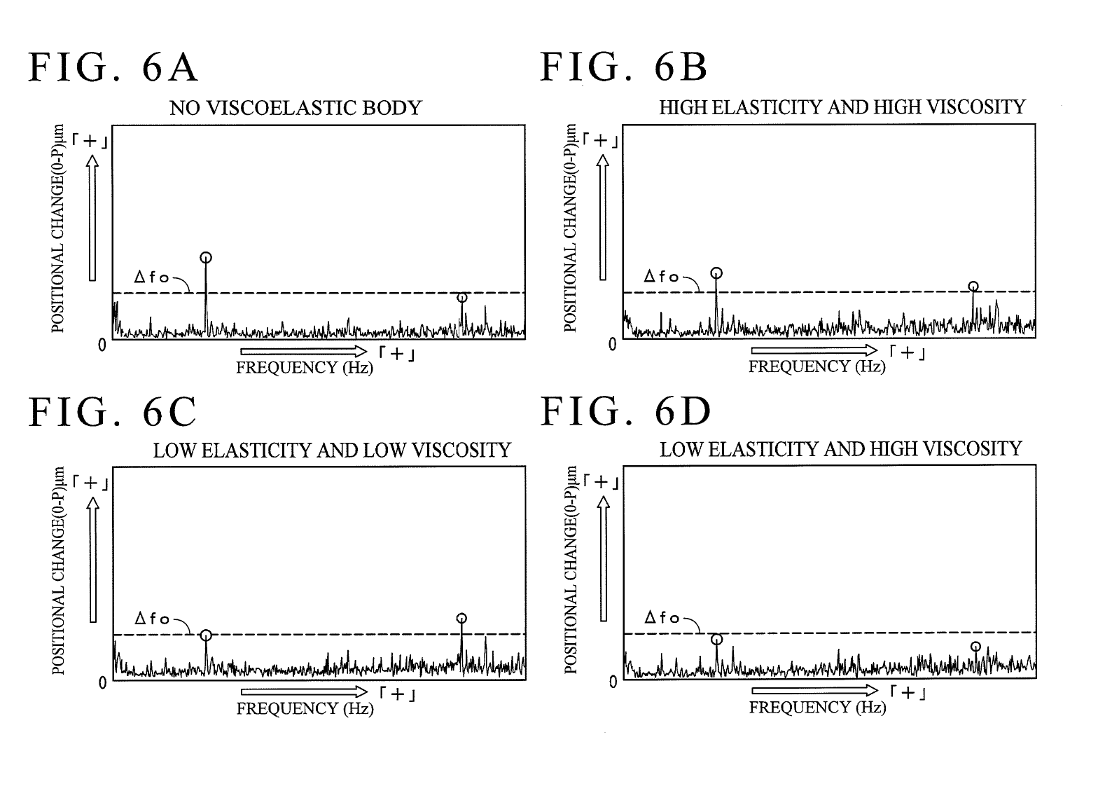

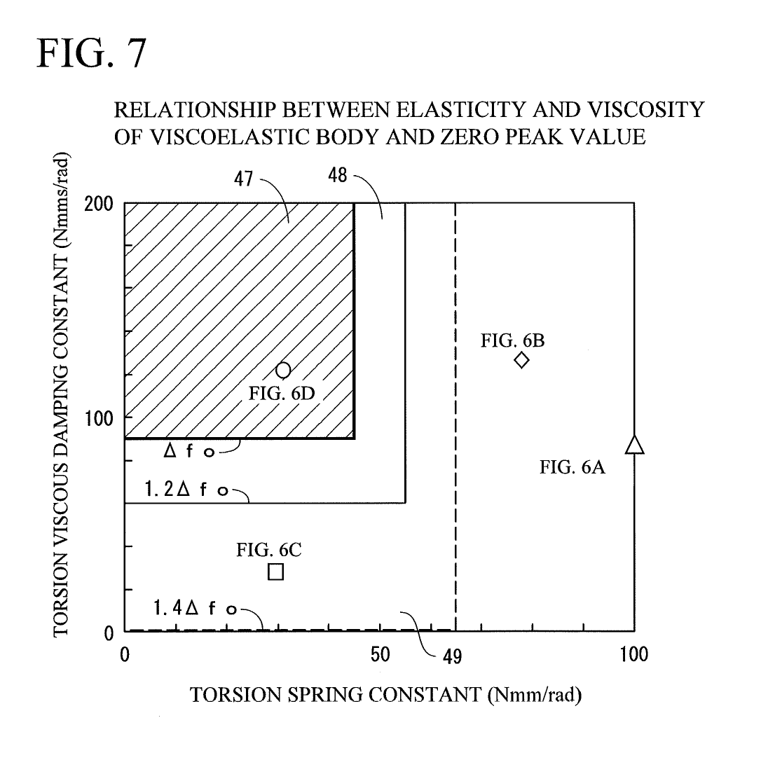

Thus, the present inventors have examined the effect of the elasticity and the viscosity of the viscoelastic body 44 on the varying rotation rates of the photoreceptor 13. FIGS. 6A to 6D show representative examples of the results of the examination. Each of the graphs of FIGS. 6A to 6D show frequencies on the horizontal axis and 0-P values of positional change (zero-peak values, which are the maximum positional changes) on the vertical axis. For example, the torsion spring constant K of the viscoelastic body 44 with high elasticity used in the examination is about 80 Nmm/rad and the torsion spring constant K of the viscoelastic body 44 with low elasticity used in the examination is about 30 Nmm/rad. The torsion viscous damping constant C of the viscoelastic body 44 with high viscosity is about 120 Nmms/rad and the torsion viscous damping constant C of the viscoelastic body 44 with low viscosity is about 30 Nmms/rad. The positional change values are obtained in the following manner. The surface of the photoreceptor 13 is irradiated with a laser beam of a laser Doppler to measure the rotation rate of the photoreceptor 13, and variations of the rotation rate of the photoreceptor 13 are converted into the positional change values. In a case where no viscoelastic body 44 is provided, the output branching gear 45 is directly coupled to the boss section 43 of the photoreceptor gear 42.

In the case shown in FIG. 6A where no viscoelastic body 44 is provided, two large zero peak values are respectively present in a low frequency range and a high frequency range. This is the state where the rotational oscillation is not damped. The similar result is to be obtained with a condition of high elasticity and low viscosity (large torsion spring constant K and small torsion viscous damping constant C). The example shown in FIG. 6B is where the viscoelastic body 44 has high elasticity and high viscosity (large torsion spring constant K and large torsion viscous damping constant C). In the case of FIG. 6B, two large zero peak values are respectively present in a low frequency range and a high frequency range as in FIG. 6A. Thus, the rotational oscillation is almost not damped at all. The example shown in FIG. 6C is where the viscoelastic body 44 has low elasticity and low viscosity (small torsion spring constant K and small torsion viscous damping constant C). In the case of FIG. 6C, compared with the cases of FIGS. 6A and 6B, the zero peak value in the low frequency range is smaller due to the low elasticity, but the zero peak value in the high frequency range is larger. Thus, the rotational oscillation in the high frequency range is not damped.

The example shown in FIG. 6D is where the viscoelastic body 44 has low elasticity and high viscosity (small torsion spring constant K and large torsion viscous damping constant C). In the case of FIG. 6D, the zero peak value in the low frequency range is small due to the low elasticity, and the zero peak value in the high frequency range is also small due to the high viscosity. Accordingly, under the condition of low elasticity and high viscosity, the two zero peak values respectively in the low and high frequency ranges can be made small, and thus the viscoelastic body 44 appropriately damps the rotational oscillation.

Based on the examination results described above, the present inventors have searched for the combination of the constants K and C that makes a zero peak value Δf (maximum positional change value) of the photoreceptor 13 at each of the two positions in the low frequency range and the high frequency range equal to or smaller than a predetermined positional change value Mo. FIG. 7 is a graph obtained by converting the representative examination results of FIGS. 6A to 6D into relationships between the elasticity and viscosity characteristics of the viscoelastic body 44 and the zero peak value Δf of the photoreceptor 13. The graph of FIG. 7 shows the torsion spring constants K on the horizontal axis and the torsion viscous damping constants C on the vertical axis.

A hatched portion 47 surrounded by a thick solid line in FIG. 7 represents a region where the zero peak value Δf is equal to or smaller than the predetermined positional change value Δfo (Δf≦Δfo). An open portion 48 surrounded by a thin solid line represents a region where the zero peak value Δf is larger than the predetermined positional change value Δfo but is not larger than 1.2 times of the predetermined positional change value Δfo (Δfo<Δf≦1.2×Δfo). An open portion 49 surrounded by a dotted line represents a region where the zero peak value Δf is larger than 1.2 times of the predetermined positional change value Δfo but is not larger than 1.4 times of the predetermined positional change value Δfo (1.2×Δfo<Δf≦1.4×Δfo). Here, the predetermined positional change value Δfo is 0.5((0-p)μm).

The result in FIG. 7 obtained by the conversion shows that, as elasticity and viscosity characteristics that make the zero peak value Δf not larger than the predetermined positional change value Δfo (here, 0.5(0-p)μm), the torsion spring constant K and the torsion viscous damping constant C of the viscoelastic body 44 respectively may be equal to or smaller than 45 Nmm/rad and equal to or larger than 90 Nmms/rad. With the viscoelastic body 44 satisfying the condition, for example, the rotational oscillation resulting from the varying rotation rates of the driving motor 40 can be damped by the effect of the torsion spring constant K, and the rotational oscillation resulting from the varying loads on the developer 15 can be damped by the effect of the torsion viscous damping constant C. In other words, the viscoelastic body 44 alone can appropriately damp the oscillations of the different causes. Thus, varying rotation rates of the photoreceptor 13 can be surely reduced and a high quality image can be provided.

### (3) Second Embodiment of Power Transmission Structure, Directed to Image Forming Unit

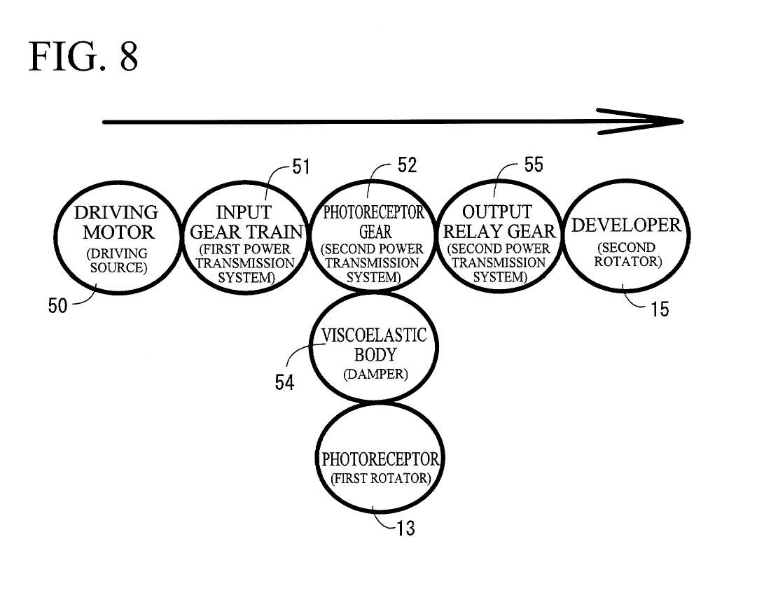

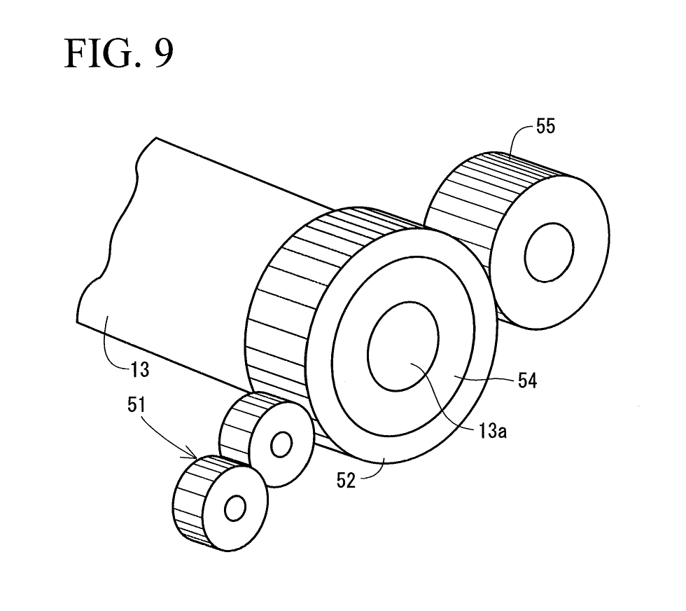

Referring to FIG. 8 and FIG. 9, a second embodiment of the power transmission structure, which is directed to the image forming unit 7, will be described. In the second embodiment, the power generated by a driving motor 50 is transmitted to the photoreceptor 13 and the developer 15 in this order (see FIG. 8). A photoreceptor gear 52 is a component of the second power transmission system and is unremovably secured to the rotary shaft 13a of the photoreceptor 13. A viscoelastic body 54 serving as a damper is provided between the photoreceptor gear 52 and the rotary shaft 13a. An input gear train 51 serving as the first power transmission system meshes with the photoreceptor gear 52 to transmit power to the photoreceptor gear 52. The photoreceptor gear 52 is power transmittably coupled to the developer 15 through an output relay gear 55. The viscoelastic body 54 may be similar to that in the first embodiment. That is, the viscoelastic body 54 may be used that has the elasticity and viscosity characteristics that make the zero peak value Δf equal to or smaller than the predetermined positional change value Δfo (the torsion spring constant K and the torsion viscous damping constant C of the viscoelastic body 54 respectively being equal to or smaller than 45 Nmm/rad and equal to or larger than 90 Nmms/rad).

### (4) Third Embodiment of Power Transmission Structure, Directed to Periphery of Intermediate Transfer Belt

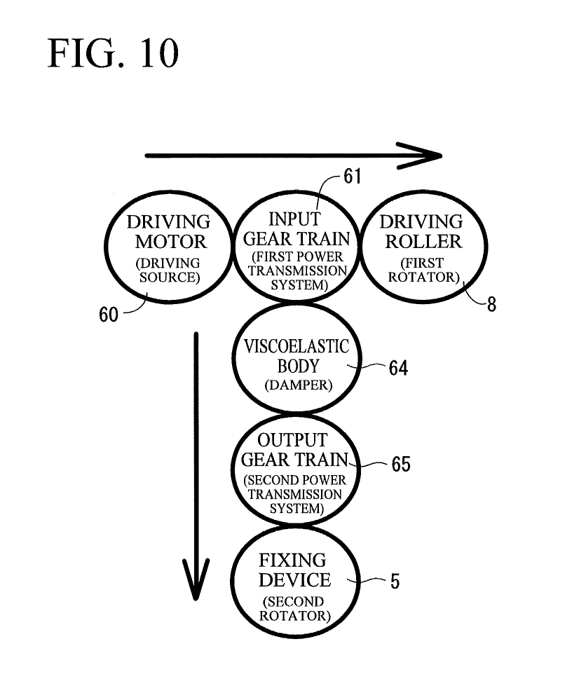

A third embodiment of the power transmission structure, which is directed to the periphery of the intermediate transfer belt 6, will be described by referring to FIG. 10. In the third embodiment, the power generated by a driving motor 60, which is a driving source disposed on a side of the casing 2 of the printer 1, is branched into two directions, namely, to the driving roller 8 serving as the first rotator and to the fixing device 5 (which includes the fixing roller 31 and the pressure roller 32) serving as the second rotator. That is, part of the power generated by the driving motor 60 is transmitted to the driving roller 8 through a first power transmission system 61, which includes an input gear train. The rest of the power is transmitted to the fixing device 5 from the first power transmission system 61 through a viscoelastic body 64 serving as a damper and a second power transmission system 65, which includes an output gear train. The driving roller 8, around which the intermediate transfer belt 6 is wound, serves as an intermediate transferer. The viscoelastic body 64 may be similar to those in the first and the second embodiments.

### (5) Fourth Embodiment of Power Transmission Structure, Directed to Periphery of Intermediate Transfer Belt

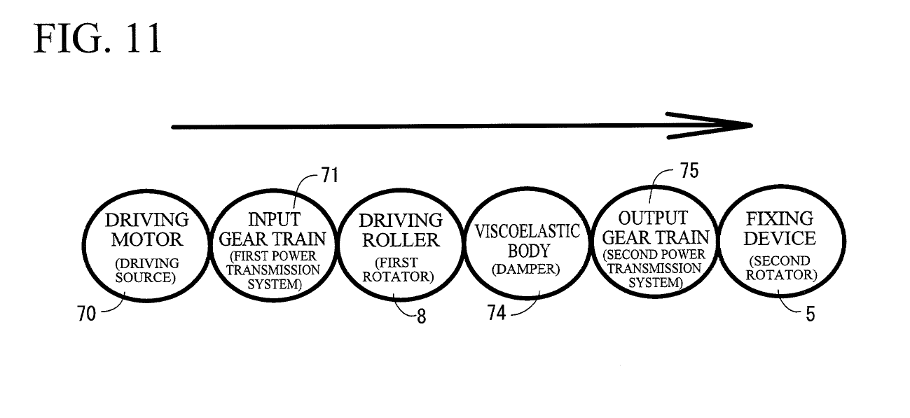

A fourth embodiment of the power transmission structure, which is directed to the periphery of the intermediate transfer belt 6, will be described by referring to FIG. 11. In the fourth embodiment, the power generated by a driving motor 70 is transmitted to the driving roller 8 and the fixing device 5 in this order. Specifically, the power generated by the driving motor 70 is transmitted to the driving roller 8 through a first power transmission system 71, which includes an input gear train. The power transmitted to the secondary transfer roller 10 is transmitted to the fixing device 5 through a viscoelastic body 74 serving as a damper and the second power transmission system 75, which includes an output gear train. Also in this case, the viscoelastic body 74 may be similar to those in the first to the third embodiments.

### (6) Other Notes

It will be appreciated that the present invention will not be limited to the embodiments described above and can be embodied in various other forms. For example, while a printer has been described as an exemplary image forming apparatus, this should not be construed in a limiting sense. Other possible examples include copiers, fax machines, and multi-function machines integrally incorporating copy and fax capabilities. Also the second rotator may include a plurality of rotators. For example, in the third and the fourth embodiments, the sheet feeder 4 may serve as a third rotator and be disposed further downstream than the driving roller 8, which serves as the first rotator, in the flow of power transmission. In this case, the power transmission structure relative to the other rotators preferably includes a power transmission system and a damper between the third rotator and the other rotators. Moreover, the location or arrangement of individual elements in the illustrated embodiments should not be construed in a limiting sense. Various modifications can be made without departing from the scope of the present invention.

In the embodiments, the damper to damp oscillation is disposed between a first power transmission system that transmits power from a driving source to a first rotator or the first rotator and a second power transmission system that transmits power to a second rotator. The damper has a torsion spring constant and a torsion viscous damping constant making a maximum positional change value of the first rotator equal to or smaller than a predetermined positional change value. Thus, the rotational oscillation resulting from the varying rotation rates of the driving source can be damped by the effect of the torsion spring constant, and the rotational oscillation resulting from the varying loads on the second rotator can be damped by the effect of the torsion viscous damping constant. In other words, the damper alone can appropriately damp the oscillations of the different causes. This, as a result, significantly reduces varying rotation rates of the first rotator and minimizes image blurring (banding), thereby improving image quality.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus comprising:
a driving source configured to generate power;
a first rotator configured to be drivingly rotated by the power generated by the driving source;
a first power transmission system configured to transmit the power from the driving source to the first rotator;
a second rotator configured to be drivingly rotated by the power generated by the driving source; and
a second power transmission system configured to transmit the power to the second rotator from the first power transmission system or from the first rotator,
wherein a damper to damp oscillation is disposed between the first power transmission system and the second power transmission system or between the first rotator and the second power transmission system, and
wherein the damper has a torsion spring constant and a torsion viscous damping constant making a maximum positional change value of the first rotator equal to or smaller than a predetermined positional change value.

2. The image forming apparatus according to claim 1,
wherein the torsion spring constant of the damper is equal to or smaller than 45 Nmm/rad, and
wherein the torsion viscous damping constant of the damper is equal to or larger than 90 Nmms/rad.

3. The image forming apparatus according to claim 1, wherein the damper comprises a viscoelastic body configured to couple the second power transmission system to the first power transmission system or the first rotator so as to rotate the second power transmission system in conjunction with the first power transmission system or the first rotator.

4. The image forming apparatus according to claim 3,
wherein the second power transmission system and the first power transmission system or the first rotator are coaxially disposed, and
wherein the damper is disposed in an annular form between the second power transmission system and the first power transmission system or the first rotator.
